(19) United States
(12) Patent Application Publication
(10) Pub. No.: US 2026/0087612 A1
(43) Pub. Date: Mar. 26, 2026

(54) MACHINE LEARNING BASED GENERATION OF SYNTHETIC FAULT IMAGES OF SEMICONDUCTOR SPECIMENS

(71) Applicant: Applied Materials Israel Ltd., Rehovot (IL)

(72) Inventors: Boris SHERMAN, Rehovot (IL); Boris LEVANT, Rehovot (IL); Ran BADANES, Rishon Le-Zion (IL); Bar DUBOVSKI, Beit Hashmonay (IL); Tomer YEMINY, Givat Shmuel (IL); Ran YACOBY, Jerusalem (IL)

(21) Appl. No.: 18/893,821

(22) Filed: Sep. 23, 2024

(51) Int. Cl. G06T 7/00

(52) U.S. Cl. CPC G06T 7/001; G06T 2207/10061; G06T 2207/20081; G06T 2207/20084; G06T 2207/30148

(57) ABSTRACT

The presently disclosed subject matter includes a computer system and a computer-implemented method of generating synthetic examination output images, including synthetic fault images and synthetic fault-free images. The synthetic images comprise artificially generated 3D defects. A machine learning model is trained for transforming examination output images to height maps. The height maps are modified to include certain 3D features, and a second machine learning model is used for transforming the height maps to modified examination output images to exhibit the 3D features.

### TECHNICAL FIELD

The presently disclosed subject matter is related to fabrication and examination of semiconductor specimens.

### BACKGROUND

Current demands for high density and performance associated with the ultra-large-scale integration of fabricated devices require submicron features, increased transistor and circuit speeds, and improved reliability. As semiconductor processes advance, pattern dimensions such as line width, along with other critical dimensions, are continuously reduced. These demands necessitate the formation of device features with high precision and uniformity, which, in turn, requires meticulous monitoring of the fabrication process, including automated examination of devices while they are still in the form of semiconductor wafers.

Semiconductor examination is a crucial part of the semiconductor manufacturing process, involving the inspection of semiconductor wafers for defects of interest (DOIs) to ensure quality. DOIs may arise from various factors, including manufacturing process errors, material imperfections, contamination during fabrication, or equipment malfunctions. This process employs advanced technologies such as optical microscopy, electron microscopy, and automated scanning systems to identify defects like cracks, misalignments, or impurities. These imperfections can significantly impact the yield rate and the performance of the final product. Even the smallest fault in a semiconductor can severely affect the functionality of electronic devices such as computers, smartphones, and other digital equipment, making this inspection process essential for maintaining the reliability and efficiency of electronic components. Additionally, effective defect detection reduces manufacturing costs and waste, as undetected defects can lead to substantial resource loss.

### General Description

According to a first aspect of the presently disclosed subject matter there is provided a computer-implemented method of generating height maps of a semiconductor specimen, the method comprising:

obtaining one or more examination output images generated by a semiconductor examination tool; applying a first machine learning (ML) model on the one or more examination output images to generate one or more respective height maps; wherein the first machine learning model is a model trained with a training dataset that includes examination output images of a semiconductor specimen and respective height maps, and is dedicated to converting examination output images to height maps while utilizing a loss function dedicated to maintaining consistency between the examination output images and the respective height maps and thereby avoid artifacts commonly found in height maps generated based on examination output images (e.g., generated by non ML height map generation algorithms).

In addition to the above features, the method according to this aspect of the presently disclosed subject matter can optionally comprise one or more of features (i) to (ix) below, in any technically possible and technically possible combination or permutation:
i. The computer method comprises:
   modifying the one or more respective height maps by adding at least one topographic feature, thereby generating one or more modified height maps; and
   applying a second machine learning (ML) model to the one or more modified height maps to convert the one or more modified height maps to one or more respective modified synthetic examination output images of the semiconductor specimen.
ii. Wherein the first ML model and the second ML model are trained concurrently in a cyclic training process.
iii. Wherein the first machine learning model and the second machine learning model each apply a loss function dedicated to maintaining consistency between the examination output images and the respective height maps; wherein the loss function includes one or more of the following loss components:
   a generative adversarial loss component configured to optimize generators for converting between height maps and SEM images by encouraging outputs indistinguishable from real data in the target domain;
   a cycle-consistency loss component configured to maintain cycle-consistency in the conversion between height maps and SEM images in both directions;
   a reconstruction loss component configured to ensure accurate replication of bidirectional transformations between SEM images and height maps using a predetermined error metric; and
   a smoothness component configured to ensure gradients consistency between outputs and comprising two terms: a first term that ensures the gradients of the generated height maps are consistent with the gradients of the generated SEM images, and a second term that ensures the gradients of the generated SEM images are consistent with the gradients of the generated height maps.
iv. Wherein a new topographic feature is an artificially generated 3-dimensional defect, wherein the one or more modified height maps include at least one fault height map that includes at least one artificially generated 3-dimensional defect, and wherein the one or more modified examination output images include one or more synthetic fault images, exhibiting data indicative of the at least one artificially generated 3-dimensional defect.
v. Wherein the one or more synthetic fault images are generated as part of execution of a defect detection process, dedicated for detecting 3D defects in examination output images of a semiconductor; wherein the method comprises, as part of the defect detection process:
   generating a training dataset comprising a collection of examination output images including the one or more synthetic fault images and a plurality of fault-free images;
   utilizing the training dataset for training a third machine learning model dedicated for receiving examination output images of a semiconductor specimen and detecting defects therein; and
   applying the third machine learning model to examination output images of the semiconductor specimen acquired by the examination tool, to thereby detect defects in the semiconductor specimens.
vi. Wherein the defect detection process is executed as part of a semiconductor examination process for detecting defects in real-time during examination.
vii. Wherein the examination tool is a Scanning Electron Microscope (SEM) and the examination output images are SEM output images.
viii. Wherein the one or more examination output images include one or more fault-free images; the method comprising:
   applying the first ML model on the one or more fault-free images, thereby obtaining one or more respective height maps;
   applying a second machine learning (ML) model to the one or more respective height maps to convert the one or more respective height maps to one or more respective fault-free synthetic examination output images of the semiconductor specimen.
ix. The computer-implemented method comprises:
   obtaining one or more material maps of the semiconductor specimen; wherein a material map represents the distribution and composition of different materials across the semiconductor specimen; the one or more material maps are modified material maps that each include at least one artificially generated material defect;
   applying the second machine learning (ML) model to the one or more material maps in addition to the modified height maps, to convert the one or more modified height maps and material maps to one or more respective modified synthetic examination output images that include at least one 3-dimensional defect and at least one material defect.

According to a second aspect of the presently disclosed subject matter there is provided a computer system comprising a processing circuitry configured to execute the method of the first aspect above.

According to a third aspect of the presently disclosed subject matter there is provided a non-transitory computer readable medium comprising instructions that, when executed by a computer, cause the computer to perform a method according to the first aspect above.

According to a fourth aspect of the presently disclosed subject matter there is provided a computer-implemented method of generating modified examination output images of a semiconductor specimen, the method comprising:
obtaining one or more examination output images generated by a semiconductor examination tool; applying a first machine learning (ML) model on the one or more examination output images to generate one or more respective height maps; wherein the first machine learning model is a model trained with a training dataset that includes examination output images of a semiconductor specimen and respective height maps, and is dedicated to converting examination output images to height maps while reducing (or avoiding) artifacts commonly found in height maps generated based on examination output images;
modifying the one or more respective height maps by adding at least one topographic feature, thereby generating one or more modified height maps; and
applying a second machine learning (ML) model to the one or more modified height maps to convert the one or more modified height maps to one or more respective modified synthetic examination output images of the semiconductor specimen.

According to a fifth aspect of the presently disclosed subject matter there is provided a computer implemented method dedicated to generating a dataset for training a machine learning model dedicated for detecting defects in examination output images of a semiconductor specimen; the method comprising:
obtaining examination output images generated by a semiconductor examination tool; applying a first machine learning (ML) model on the examination output images to generate respective height maps; wherein the first machine learning model is a model trained with a training dataset that includes examination output images of a semiconductor specimen and respective height maps, and is dedicated to converting examination output images to height maps while reducing (or avoiding) artifacts commonly found in height maps generated based on examination output images;
   modifying the respective height maps by adding at least one topographic feature to each respective height map, thereby generating a collection of modified height maps; wherein the topographic feature includes at least one 3-dimensional defect;
applying a second machine learning (ML) model to the collection of modified height maps to convert the collection of modified height maps to a respective collection of modified synthetic examination output images of the semiconductor specimen; and
generating a training dataset that includes the respective collection of modified synthetic examination output images and a collection of a plurality of fault-free images;
utilizing the training dataset for training a third machine learning model dedicated for receiving examination output images of a semiconductor specimen and detecting defects therein; and
applying the third machine learning model to examination output images of the semiconductor specimen acquired by the examination tool, to thereby detect defects in the semiconductor specimens.

According to a sixth aspect of the presently disclosed subject matter there is provided a computer-implemented method of generating synthetic fault examination output images comprising at least one artificially generated material defect; the method comprising:
obtaining one or more material maps of the semiconductor specimen; wherein a material map represents the distribution and composition of different materials across the semiconductor specimen; the one or more material maps are modified material maps that each include at least one artificially generated material defect;
applying a machine learning (ML) model to the one or more material maps, the ML model being trained to convert the one or more material maps to one or more respective modified synthetic examination output images that exhibit the one or more artificially generated material defects.

The present disclosure further contemplates a computer system configured to execute the method of any one of the fourth, fifth, and sixth aspects, and a non-transitory program storage device comprising instructions that, when executed by a computer, cause the computer to perform a method according to any one of the fourth aspect and fifth aspect above.

The methods, the systems, and the non-transitory program storage devices, disclosed with reference to the second, third, fourth, and fifth aspects, can optionally comprise one or more of features (i) to (ix) listed above, mutatis mutandis, in any technically possible combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1a shows a block diagram schematically illustrating an examination system, in accordance with certain examples of the presently disclosed subject matter;

FIG. 1b illustrates a block diagram schematically illustrating components of synthetic images generator, in accordance with certain examples of the presently disclosed subject matter;

FIG. 1c shows another block diagram schematically illustrating an examination system, in accordance with certain examples of the presently disclosed subject matter;

FIG. 2 is a high-level flowchart showing operations carried out as part of a defects detection process, in accordance with certain examples of the presently disclosed subject matter;

FIG. 3 is a flowchart showing operations carried out as part of an augmented defects detection process, in accordance with certain examples of the presently disclosed subject matter;

FIG. 4a is a flowchart showing operations carried out as part of a synthetic fault images generation process, according to some examples of the presently disclosed subject matter;

FIG. 4b is a flowchart showing operations carried out as part of the generation of the augmented machine learning model involving the synthetic fault images generation process, in accordance with certain examples of the presently disclosed subject matter;

FIG. 5 illustrates a 3D defects implanting process in a height map using Perlin noise, in accordance with certain examples of the presently disclosed subject matter;

FIGS. 6a and 6b show examples of the transformation of a height map to respective SEM output images;

FIG. 7 is a flowchart showing operations carried out as part of a dynamic defects detection process, in accordance with certain examples of the presently disclosed subject matter;

FIG. 8 is a flowchart showing operations carried out as part of the training of IMAGE-2-HM conversion model 114, in accordance with certain examples of the presently disclosed subject matter; and

FIG. 9 is a flowchart showing operations carried out as part of a synthetic fault images generation process using an IMAG-2-HM ml model, according to some examples of the presently disclosed subject matter.

### DETAILED DESCRIPTION

A wafer is a thin, typically circular slice of semiconductor material, often silicon, that serves as a substrate for manufacturing integrated circuits. A semiconductor die is an independent and discrete component of an integrated circuit, such as an individual computer processor. Each die contains a specific set of electronic components, all fabricated together on the same wafer. Generally, during the fabrication process, multiple dies are created on a single wafer, each being a copy of the same integrated circuit design, effectively yielding identical copies of the integrated circuit.

The process of semiconductor fabrication involves multiple sequential processing steps or layers, each of which can introduce errors that may lead to yield loss. Examples of these steps include lithography, etching, deposition, planarization, growth (such as epitaxial growth), and implantation. Various defect examination operations, such as detection, review, and classification, are performed at different processing steps or layers during the fabrication process to monitor and control quality. These examination operations can be repeated multiple times, for example after certain processing steps or layers.

Machine learning (ML) technologies are sometimes used to assist the detection process to provide more accurate and efficient solutions. However, using ML for defect detection during semiconductor examination presents various challenges.

One challenge in using ML for defect identification in semiconductor imaging is the limited availability of fault examination output images (e.g., output images of Scanning Electron Microscopy) comprising defects, which are needed, among other things, for training the model. In high-quality manufacturing environments, actual defects are rare, resulting in datasets skewed towards non-defective examples. This imbalance undermines the ability of the ML model to effectively recognize and learn from rare defect instances. Furthermore, the diversity in die patterns introduces a wide range of potential defects, adding complexity to the training process, which requires a broad spectrum of data. Rapid technological advancements within the semiconductor industry further complicate this issue by quickly rendering existing training data obsolete.

Human annotation of defects in examination output images also presents several drawbacks. It is a time-consuming process that delays model development and is prone to subjectivity and inconsistency, as different annotators might interpret defects differently, affecting model reliability. Moreover, the manual process does not scale well with increasing data volumes, making it impractical for large datasets. The task requires specialized knowledge, limiting the pool of qualified annotators, and is error-prone, particularly when annotators are fatigued, impacting data quality. Annotators may also miss subtle defects and provide superficial labels, limiting the training data's utility.

Moreover, the challenge is further heightened when dealing with three-dimensional (3D) defects, which require specialized equipment for accurate imaging and data collection. Acquiring high-quality data of real 3D defects is often costly, time-consuming, and labor-intensive, requiring expertise in both domain and data handling. The limited availability of such datasets restricts the ability of researchers and practitioners to train and validate machine learning models effectively.

The scarcity of fault images with defect examples not only affects ML-based approaches, but also poses challenges for traditional, non-ML algorithms. Without a sufficient number of representative defect samples, it becomes difficult to validate and benchmark the performance of these algorithms, hindering their development and optimization.

The presently disclosed subject matter includes a computer system and a computer-implemented method of generating synthetic examination output images (or “synthetic images”), including synthetic fault images and synthetic fault-free images. With respect to the generation of synthetic fault images, the proposed technique involves using a height map generation algorithm for transforming examination output images of a semiconductor specimen into a respective plurality of height maps, incorporating synthetic defects into the height maps, and applying a machine learning model to the height maps, dedicated for transforming the height maps into synthetic fault images exhibiting 3D defects (e.g., synthetic fault SEM images).

This approach of generating synthetic fault images offers various advantages over previous approaches. It allows the creation of a balanced training dataset, despite the rarity of actual defects in high-quality manufacturing environments. By artificially generating fault images, this method ensures a sufficient volume of defect examples for training ML models, addressing the issue of skewed datasets. Moreover, synthetic fault images can be designed to include a variety of defect types, across different semiconductor patterns, enhancing the models' ability to recognize and adapt to diverse and complex defect scenarios.

This approach also enables the generation of nominal examination output images (commonly referred to as “No Visible Defects” or NVDs), which helps to enrich the NVDs and improve the classification and segmentation tasks performed using these images. Additionally, it can enhance the variability within the NVDs, allowing for the inclusion of more diverse features, such as different patterns and other characteristics.

As further discussed below, the disclosed technique can be integrated into the semiconductor fabrication process and rapidly adjusted on-the-fly to reflect technological changes and advancements in semiconductor design and manufacturing. This ensures that the training data remains relevant and accurately aligned with the examined specimens. The scalability and adaptability of this approach significantly reduce the reliance on costly and labor-intensive human annotation, streamlining the training process and enhancing the overall efficiency and effectiveness of defect detection systems. Furthermore, unlike conventional methods that typically generate only two-dimensional (2D) defect representations, this technique enables the synthesis of both two-dimensional (2D) and three-dimensional (3D) defects, providing a more comprehensive simulation of real-world defect complexities and interactions. This capability is important, as many defects in semiconductor devices involve depth and volume, which cannot be accurately captured by standard defect synthesis methods.

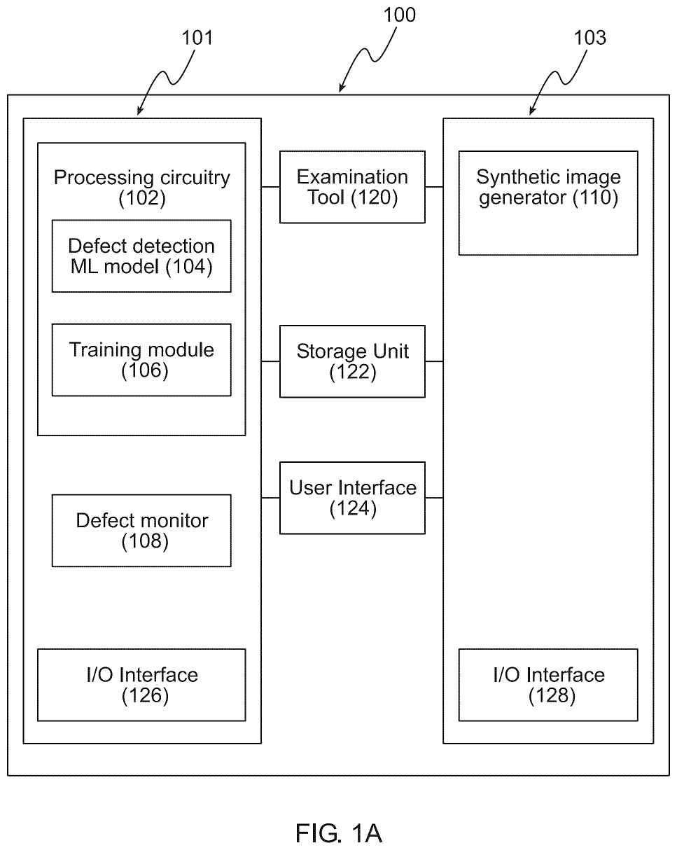

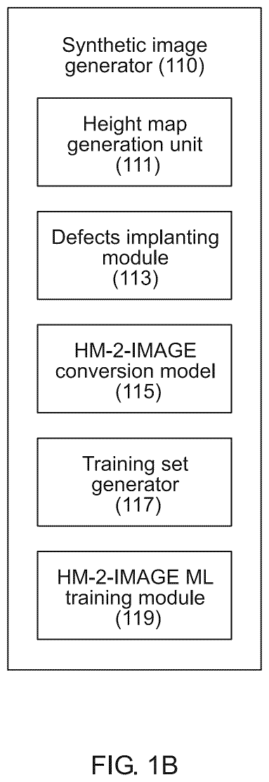

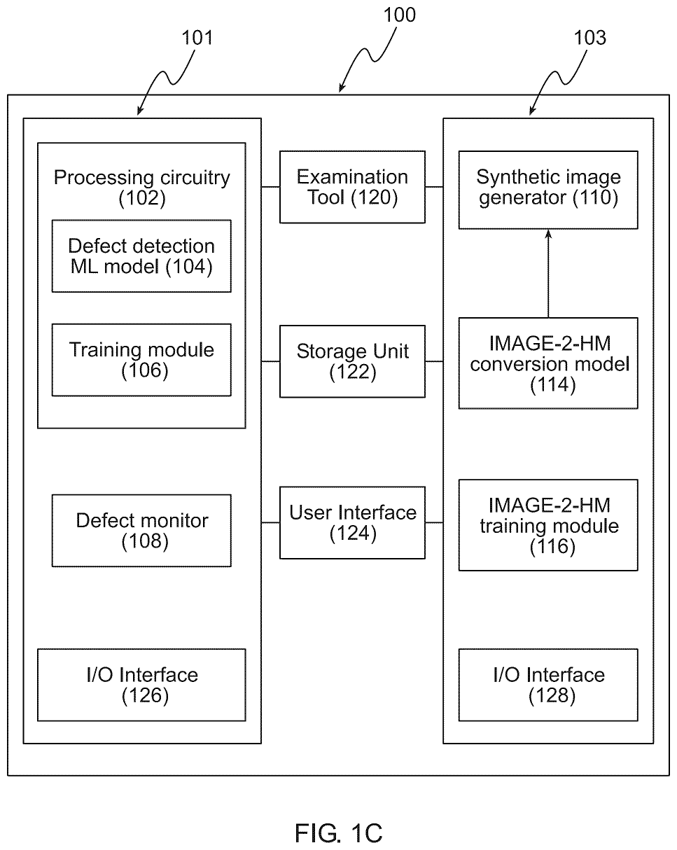

Bearing this in mind, attention is drawn to FIG. 1a showing a block diagram of an examination system in accordance with certain examples of the presently disclosed subject matter. It is noted that while the synthesis of artificial fault images is described below in the context of an examination system, this should not be construed as limiting the scope to this context alone. The methods and techniques discussed can be applied to a variety of other applications and systems where generation of synthetic fault images is relevant.

The examination system 100 illustrated in FIG. 1a can be used for examination of a semiconductor specimen (e.g., a wafer, a die, or parts thereof), for example, as part of the specimen fabrication process. The examination referred to herein can be construed to cover any kind of operations related to defect inspection/detection, defect classification of various types, segmentation, and/or metrology operations with respect to the specimen. System 100 comprises one or more examination tools 120 configured to examine (e.g., scan) a specimen and capture images thereof to be further processed by various examination applications.

The term “examination tool” as used herein should be broadly interpreted to cover any tool used in examination-related processes of a semiconductor specimen, including, but not limited to, scanning, imaging, reviewing, measuring, classifying, and/or other related operations on the specimen or its parts. The examination tools (120) can be implemented as various types of machines. In some examples, the examination tool may be an electron beam machine, such as a Scanning Electron Microscope (SEM) or a Transmission Electron Microscope (TEM), an Atomic Force Microscope (AFM), X-ray microscopy, or other similar tools. It should be noted that the presently disclosed subject matter can work with examination output images from different types of examination tools and is not limited to any specific tool. Any reference to a particular type of examination tool (predominantly SEM) in the following description is provided by way of non-limiting example only. Images generated by an examination tool are also referred to herein as “examination output images”.

Considering an SEM, it is a type of electron microscope that produces grayscale images of a specimen by scanning it with a focused beam of electrons. The operation of an SEM involves directing a focused beam of high-energy electrons toward a sample surface. This electron beam is generated by an electron gun and then precisely focused and directed using electromagnetic lenses. As the electron beam scans across the surface of the sample, it interacts with the atoms, leading to various outcomes such as the emission of secondary electrons, backscattered electrons, and characteristic X-rays.

The detection of secondary electrons (emitted from atoms near the surface) allows for high-resolution imaging of the sample's topography. Backscattered electrons, which are the primary electrons electromagnetically deviated from the sample atoms, provide information on the composition and contrast based on atomic number differences within the sample.

Detectors designed for specific types of emissions capture the signals resulting from these interactions. This collected data is then processed to produce a grayscale image, indicating the quantity of electrons captured by the detector This number of collected electrons vary depending on the surface topography, composition, or other properties of the sample. Through this process, SEMs can generate highly detailed grayscale images of the sample surface at magnification levels unattainable with traditional optical microscopes, providing precise inspection and measurement capabilities during the manufacturing of semiconductor wafers.

Examination tools 120 may include both inspection and review tools. Inspection tools (e.g., SEM), capture images of the specimen (e.g., by scanning), which are then analyzed by defect detection algorithms to identify potential defects. The results are typically presented as a defect map, showing the distribution of defect candidates across the semiconductor specimen. Review tools (also including SEM) are configured for detailed examination of specific areas where defects have been identified, allowing for close-up, high-resolution analysis of these targeted sections of the specimen.

According to certain examples of the presently disclosed subject matter, the examination system 100 comprises a computer-based semiconductor analysis system 101 operatively connected to examination tools 120. System 101 includes a processing circuitry 102 operatively connected to a hardware-based I/O interface 126 and configured to provide processing necessary for operating the system, as further detailed with reference to the figures described below.

Processing circuitry 102 can comprise one or more processors and one or more memories (not shown separately). The one or more processors of the processing circuitry 102 can be configured to, either separately or in any appropriate combination, execute several functional modules in accordance with computer-readable instructions implemented, for example, on a non-transitory computer-readable memory comprised in the processing circuitry. Such functional modules are referred to hereinafter as comprised in the processing circuitry.

In some examples, one or more functional modules within the processing circuitry 102 can include a machine learning (ML) model 104 dedicated to processing examination output images for detecting defects (also referred to as “defect detection ML model”). Upon obtaining a plurality of images of a semiconductor specimen acquired by an examination tool (e.g., the examination tool 120), ML model 104 processes these images for defect detection and generates a set of images labeled with detected defects.

System 101 can also be configured as a training system capable of training a ML model during a training/setup phase. To this end, system 101 includes a training module 106 dedicated for training ML model 104. Once trained, ML model 104 can be used for runtime defect examination. In some examples, system 101 can train a ML model in runtime and make it available for execution immediately after training. ML model 104 can be trained in runtime using images of semiconductor specimens acquired during the fabrication process. This allows the model to adapt to variations in semiconductor design and perform on-the-fly defect detection.

It should be noted that, in some examples, defect detection ML model 104 refers to a trained ML model previously trained (e.g., by the training module 106) using a training set comprising a subset of synthetic fault images (also referred to as “synthetic fault examination output images”) and a subset of nominal images (NVDs).

According to some examples, examination system 100 includes a synthetic image generator 110 configured to generate the collection of synthetic fault images, which can be used for training/re-training the defect detection ML model 104. In some examples synthetic image generator 110 is implemented as a dedicated processing circuitry within a separate computer system or device 103 operatively connected to examination tool 120, storage unit 122, and system 101. In other examples, synthetic image generator 110 can be implemented in a separate processing circuitry within system 101. In yet another example, synthetic image generator 110 can be implemented as part of processing circuitry 102. Processing circuitry of synthetic image generator 110 can comprise one or more processors (not shown separately) and one or more memories (not shown separately) which are configured, either separately or in any appropriate combination, to execute functional modules in accordance with computer-readable instructions implemented on a non-transitory computer-readable memory comprised in the processing circuitry.

FIG. 1b is a block diagram schematically illustrating a more detailed view of various components of synthetic image generator 110, which are shown by way of non-limiting example only. These components include, in some examples, height map generation module 111 configured to apply an algorithm for generating height maps (or “3D maps”) from examination output images; defects implanting module 113 configured to implant synthetic 3D defects in the generated height maps; height map (HM)-2-IMAGE conversion ML model 115 trained and usable for generating synthetic fault (SEM) images based on the height maps; training set generator 117 configured to generate a training set for training defect detection ML model 104; and HM-2-IMAGE ML training module 119 configured to train the HM-2-IMAGE conversion ML model. Operation of system 100, particularly of processing circuitries 102 and 110, and the functional modules therein, are detailed below with reference to the figures below.

Machine learning models described herein (including, defect detection ML model 104 and HM-2-IMAGE conversion model 115) can be implemented using various types of ML models and are not limited to a specific model type or learning algorithm. In some examples, defect detection ML model 104 and HM-2-IMAGE conversion model 115 may be implemented as a deep neural network (DNN). By way of non-limiting example, the layers of the DNN can be organized following architectures such as Convolutional Neural Networks (CNN), Recurrent Neural Networks (RNN), Recursive Neural Networks, Generative Adversarial Networks (GAN), Variational Autoencoders, Diffusion models, Transformers, or other configurations. Optionally, some of the layers may be structured into multiple DNN sub-networks. Each layer of the DNN may consist of numerous basic computational elements (CE), commonly referred to as dimensions, neurons, or nodes.

The deep neural network can be pretrained prior to training and can be further iteratively adjusted or modified during training to achieve an optimal HM-2-IMAGE conversion. After each iteration, a loss function is computed to measure the quality of the HM-2-IMAGE conversion produced by the DNN module. Training can be determined to be complete when the loss function is less than a predetermined value, when a limited change in performance between iterations is achieved, or when the number of iterations reaches the allowed maximum. A set of input data used to adjust the parameters of a deep neural network is referred to as a training set.

While the teachings of the presently disclosed subject matter are not bound by the specific architecture of the ML model or DNN as described above, one example of DNN architecture that can be used for ML model 104 and/or ML model 115 is a U-Net architecture. This type of model can be regarded as being composed of two main functionalities/parts: an encoder, and a decoder. The encoder performs feature extraction by encoding the input image into features of various semantic levels. The decoder decodes these features into a segmentation map. The encoder and decoder usually include convolutional layers, fully connected layers, activation functions, normalization layers, and/or pooling layers.

According to some examples, system 100 comprises a storage unit 122, comprising one or more types of computer memory. The storage unit can be shared by processing circuitry 102 and synthetic images generator 110. In other examples, e.g., where processing circuitry 102 and synthetic images generator 110 are configured as separate entities, each may be operatively connected to a dedicated storage unit. The storage unit 122 is configured to store any data necessary for the operation of system 101, such as data related to the input and output of the system, as well as intermediate processing results generated by system 101. For example, storage unit 122 may store runtime images, height maps, and examination output images produced by the examination tool 120 and/or their derivatives. In some examples storage unit 122 can be used for storing data related to and generated by synthetic image generator 110, such as height maps and synthetic fault images generated by the synthetic image generator 110. The synthetic fault images stored can then be made available to processing circuitry 102 for further processing.

According to some examples, system 100 and/or 101 comprises a user interface 124, to enable user interaction with system 100. The user interface can be shared by processing circuitry 102 and synthetic images generator 110. In other examples, e.g., where processing circuitry 102 and synthetic images generator 110 are configured as separate entities, each may be operatively connected to a dedicated user interface. The user interface can include a display device, user interaction devices (e.g., computer mouse and keyboard) and a graphical user interface (GUI) configured to enable, inter alia, user-specified inputs related to system 100. For instance, the user may be provided, through the GUI, with options of defining certain operations and/or parameters (e.g. ML parameters). The user may also view on the display device the processing results or intermediate processing results, such as, e.g., the height maps, synthetic fault images, NVD images, detected defects, etc.

Computer systems 101 and 103 can further comprise one or more I/O interfaces (126, 128) dedicated for transmitting and receiving data with other entities. I/O interfaces can be used, for example, for data communication with examination tool 120 and between systems 101 and 103. In some cases, I/O interface is used for communicating processing output to the storage unit 122, and/or external systems, e.g., Yield Management System of a fabrication plant (fab). A Yield Management System in semiconductor manufacturing is a data management and analysis tool that collects and analyzes production data, especially during ramp-ups, to help engineers improve yield. It allows semiconductor manufacturers to manage large volumes of production analysis with fewer engineers, by generating reports based on yield data. YMS is utilized by Integrated Device Manufacturers (IDMs), fabs, fabless semiconductor companies, and Outsourced Semiconductor Assembly and Test (OSAT) providers.

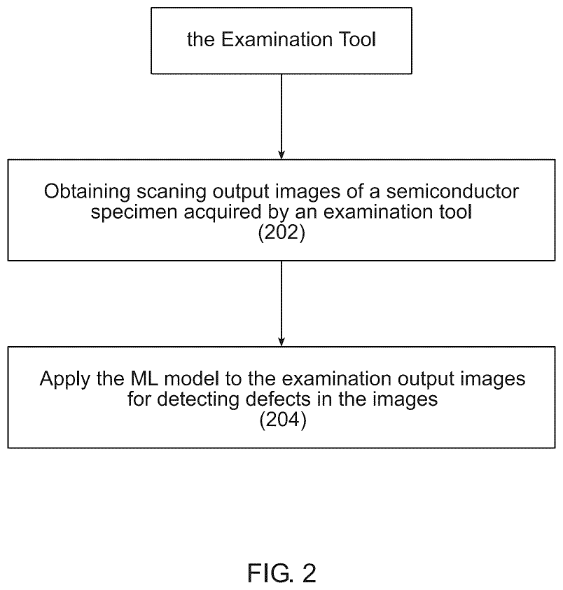

Turning to FIG. 2, it shows a high-level flowchart of operations carried out as part of the defects detection process, according to examples of the presently disclosed subject matter. It is noted that while operations in FIG. 2, as well as other figures, are described with reference to various components in FIGS. 1a, 1b, and 1c, this is done by way of example only and should not be construed as limiting the processes to the specific design illustrated in any of these figures.

A plurality of images of a semiconductor specimen acquired by an examination tool can be obtained (202) (e.g., by processing circuitry 102 from the examination tool 120). As mentioned above, such images are also referred to herein as “examination output images”. A semiconductor specimen here can refer, for example, to a semiconductor wafer, a die, or parts thereof, that is fabricated and examined in the fab during a fabrication process thereof. An image of a specimen can refer to an image capturing at least part of the specimen. By way of example, an image can capture a given region or a given structure (e.g., a structural feature or pattern on a semiconductor specimen) that is of interest to be examined on a semiconductor specimen. For instance, the image can be an image acquired in runtime during in-line examination of the semiconductor specimen. It is to be noted that the plurality of examination output images refers to real images of the specimen that are acquired by the tool, contrary to synthetic images, which are artificially generated, as will be described below.

The fabrication process of a specimen typically comprises multiple processing steps. In some cases, a sampled set of processing steps can be selected therefrom for in-line examination, based on their known impacts on device characteristics or yield. Images of the specimen or parts thereof can be acquired at the sampled set of processing steps to be examined. It is noted that the description set forth herein is applicable to any suitable processing step of a specimen, without limitation.

According to a non-limiting example, the plurality of examination output images can be processed using the defect detection ML model 104 for defect detection (204), thereby obtaining, from the plurality of examination output images, a set of images labeled with detected defects. The detected defects referred to herein can refer to any type of defective features on a specimen such as, e.g., a scratch, bump, surface roughness, bridge, particle, line-cut, protrusion, intrusion, missing pattern, etc. In some cases, the defects can also include variations related to any pattern, structure, or image, such as, e.g., bent lines, edge roughness, surface roughness, CD variation/shift, gray level variation, etc. It is to be noted that the variations referred to herein should not be limited to any specific size or resolution. A defect or “variation” in the semiconductor generally means that one or more characteristics of a design formed on the specimen are outside of a desired range of values for those one or more characteristics.

As explained above, the limited availability of fault images creates various challenges in the examination of semiconductors, including challenges related to the use of a ML model for defect detection. One of these challenges is related to difficulty in creating a training set that includes examination output images exhibiting topographic (i.e., 3D) defects, such as bumps, holes, craters, or scratches.

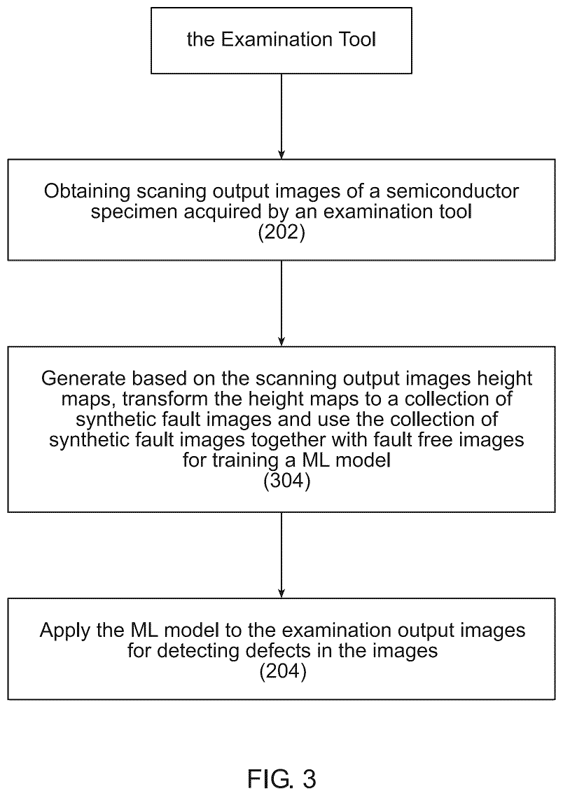

FIG. 3 is a high-level flowchart showing operations carried out as part of an augmented defects detection process, in accordance with certain examples of the presently disclosed subject matter. The term augmented in this context refers to the fact that an improved ML model for detection of 3D defects is generated.

FIG. 3 shows an alternative approach to FIG. 2, where examination output images of the semiconductor specimen generated by the examination tool are used for generating respective height maps, which, after being implanted with 3D defects, are converted back to respective synthetic fault images. Once a sufficiently large collection of synthetic fault images suitable for training a ML model is available, it is used alongside nominal (NVD) images to create a training set for training an augmented ML model specifically designed to detect specific types of defects (304).

The training set can be stored, for example, in storage unit 122 and made available to training module 106 that is configured to use the stored data for training an augmented defect detection ML model (104). The generation of synthetic fault images is based on images (e.g., NVDs) obtained from the examination tool and modified to simulate various types of defects. This approach allows for the creation of a training set exhibiting diverse 3D defects without the need for examination output images that capture true defects of the desired types. Using the height maps also eliminates the need to use design data, such as computer-aided design (CAD) files, of the semiconductor specimen, which are often unavailable as they contain valuable Intellectual Property and proprietary information and are kept secret by semiconductor manufacturers.

Once available, the augmented ML model can be applied on examination output images received from the examination tool for detecting defects in the images (204).

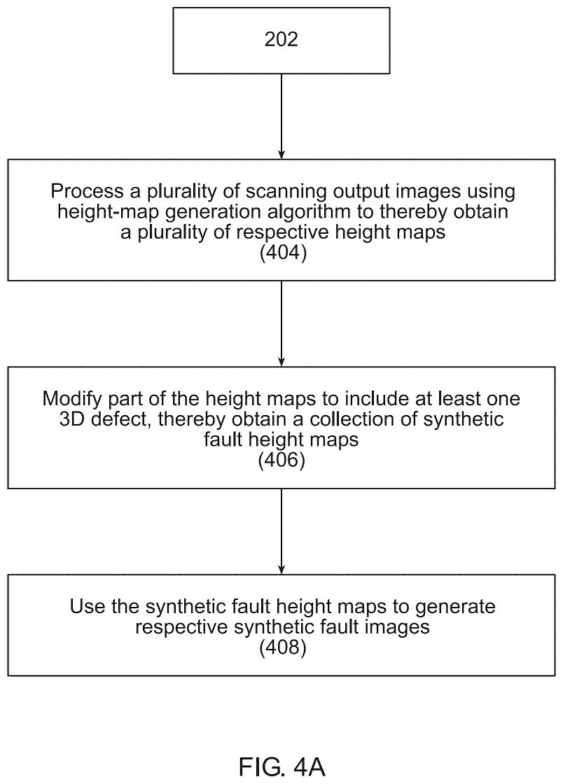

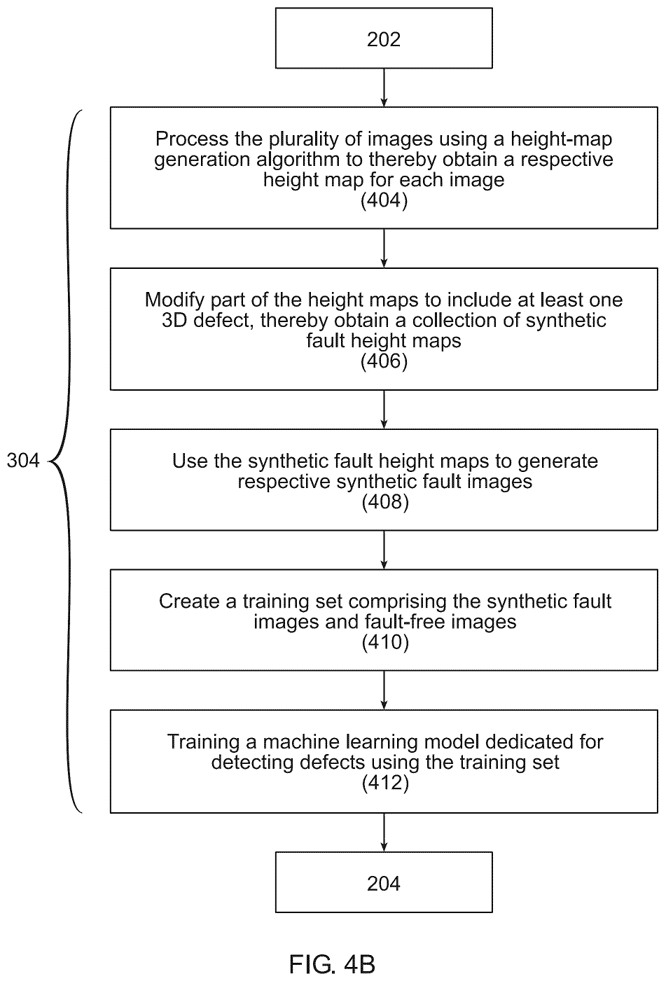

Turning to FIG. 4a, it is a flowchart depicting the operations involved in the generation of synthetic fault images, according to certain examples of the presently disclosed subject matter. FIG. 4b is a flowchart illustrating the operations involved in the development of an augmented machine learning model that is trained using synthetic fault images generated according to the process described in FIG. 4a. By way of example, operations in FIG. 4a are described primarily with respect to the synthetic image generator 110.

For ease of understanding, the operations in FIG. 4a are described in the context of FIG. 4b. However, this should not be construed as limiting the application of synthetic fault image generation to this purpose alone. In addition to their role in augmenting training datasets for machine learning models, synthetic fault images serve multiple crucial functions in semiconductor testing. For example, they can be used for benchmarking various testing methods and tools by creating standardized test sets with known faults, allowing precise performance comparisons and evaluations. Synthetic fault images also facilitate the development and validation of new fault detection algorithms, help in stress testing to ensure system robustness under different conditions, and assist in process optimization by identifying specific areas needing improvement.

As explained above, examination output images generated by the examination tool (120) are obtained (202). For example, as part of a semiconductor specimen fabrication process, a specimen can be scanned by a SEM examination tool and the SEM output images are transmitted to synthetic image generator 110.

A height map generation algorithm is applied for transforming the examination output images to respective height maps (404; e.g. by height map generation algorithm module 111). Height maps are detailed depictions of the surface topography of semiconductor materials, capturing variations in height (or depth) to provide a 3D profile of surface features.

A key principle of the height map generation algorithm is the Lambert reflection law, which describes the angular distribution of secondary electrons emitted from a sample surface under electron beam irradiation. The intensity of these emitted electrons follows a cosine relationship with the angle between the surface normal and the detector's viewing direction.

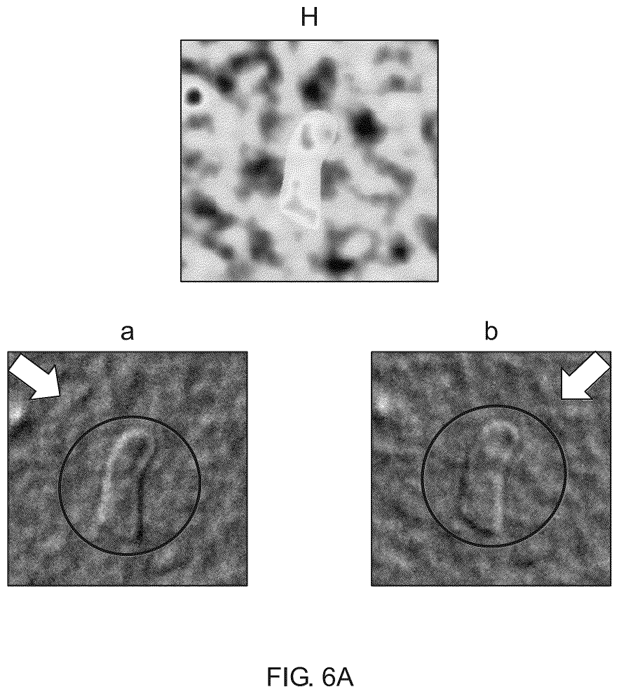

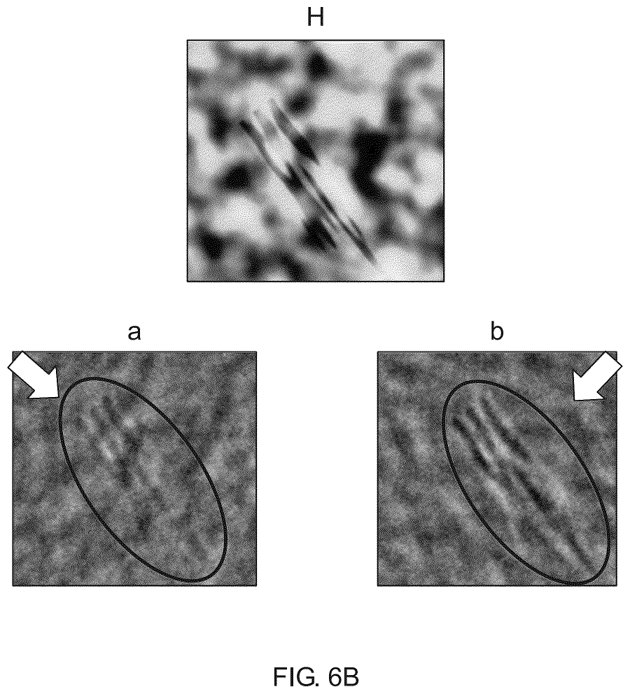

When the sample surface is flat, detectors surrounding the sample receive an equal intensity of emitted electrons, as the reflection is symmetric around the surface normal. However, if the surface exhibits topographic variations, the intensity of electrons received by each detector will vary, based on the local slope or tilt of the surface relative to the detector's viewing angle. This variation in intensity of electrons is demonstrated in FIGS. 6a and 6b referred to below. A height map can be generated using multiple respective SEM images, each corresponding to a particular perspective of the SEM.

By analyzing the relative electron intensities captured by multiple detectors positioned around the sample at different viewing angles, the 3D topography or height map of the sample surface can be reconstructed. This reconstruction accounts for both lateral (azimuthal) and altitude (elevation) angle variations, as the Lambert cosine law applies to the full 3D surface normal.

Examples of a height map generation algorithm that can be used for transforming examination output images such as SEM images into height maps by a height map generation algorithm leveraging the Lambert reflection principle include:

Stereoscopic Imaging: This model involves tilting the electron beam or sample to capture two or more SEM images from different viewing angles. The relative shifts in feature positions between these images provide depth information, enabling height map reconstruction.

Time-of-Flight: This model measures the round-trip time for the electron beam to reach the sample surface and the reflected electrons to return to the detector. This time-of-flight information is used to calculate the distance to each point on the surface, generating a height map.

Shape-from-Shading: This model applies Lambert reflection principles to analyze shading patterns in SEM images. The intensity variations are related to surface gradients, which can be integrated to recover the height map.

These height map generation algorithms, along with potential combinations or variations, can be utilized to convert acquired SEM images into height maps, allowing for high-resolution characterization of surface topography. The result of applying these height map generation algorithms to the examination output images is a collection of detailed height maps.

The collection of height maps is subjected to processing steps dedicated for implanting defects in the height maps (406; e.g., by defects implanting module 113). The modifications applied to each height map include changing the topography of the height map to represent at least one 3D defect to thereby obtain respective “synthetic fault height maps” i.e. height maps with at least one artificially generated 3D defect.

Implanting defects can be performed by applying various modification functions on the height maps. This includes, for example, inserting one or more Gaussian shapes to the height map for the implanting of a bump, or inserting an inversed Gaussian shape for implanting a crater. As is well known in the art, a 2D Gaussian shape is defined by a 2D Gaussian formula that includes parameters such mean, standard deviations, and amplitude. These parameters determine the final Gaussian shape. By adjusting these parameters in the 2D Gaussian formula, a desired bump or crater shape can be achieved.

Another example is a scratch that can be defined by parameters such as length, width, depth, orientation position, profile (e.g., rectangular, round, triangular, etc.), and smoothness.

According to some examples, a range of values of each parameter are provided (e.g., retrieved from data storage 122) and an actual value is selected from these ranges and used for creating the shape (e.g., Gaussian or scratch). The selection can be done, for example, automatically (e.g., by randomly selecting a value within each prescribed range), or by a user. Once the shape has been determined, a corresponding defect characterized by this shape is implanted in the height map. For changing the height map, the pixel heights at the planting location are modified, as prescribed by the shape of the 3D defect. In some cases, placement of the defects in the map is done by first defining various areas of exclusion, where defects should not be added (e.g., near the edges of the height map), and then selecting (e.g., randomly) a planting location within the map.

According to some examples, procedural generation commonly used in computer graphics, such as Perlin noise and Voronoi noise, are used to create 3D defects characterized by random textures and/or complex geometry. Perlin noise is a method that leverages smooth, gradient-based randomness to simulate natural variations and intricate surface details. By adjusting parameters such as scale, frequency, and amplitude, Perlin noise can generate realistic 3D defect patterns.

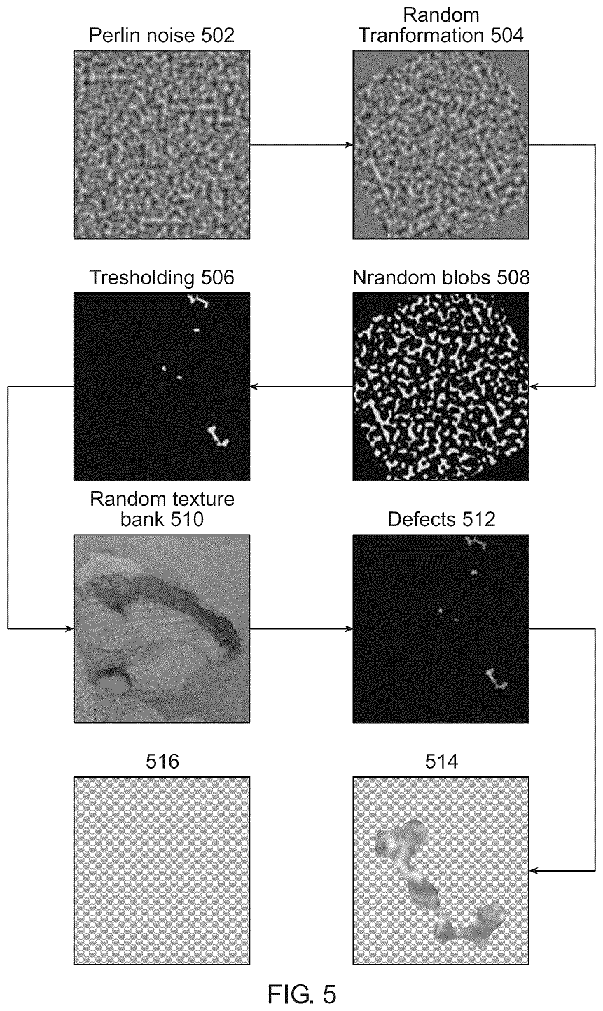

FIG. 5 illustrates an example of 3D defects implanting in a height map using Perlin noise. In the first step, Perlin noise is generated (502). The process of adding 3D features to the height map by applying Perlin noise involves defining the Perlin noise with two key aspects:

Seed Value: This value defines the starting point for randomness within the Perlin noise function. Using the same seed value will always produce the same noise pattern, ensuring reproducibility.

Perlin Noise Parameters: These parameters, such as scale, octaves, persistence, and lacunarity, influence the characteristics of the noise based on the seed's randomness. They define properties like the level of detail, roughness, and distribution of features within the generated noise.

The Perlin noise function uses the seed value and the parameters to calculate and combine multiple octaves of noise to create the final result. Each octave has a different frequency and amplitude. The base octave has the largest features and the highest influence, while higher octaves add finer details. Combining these octaves produces a complex and realistic 3D surface that captures natural-looking variations and intricate details. The generated noise values can be mapped onto the height map grid at the planting location to determine updated elevations.

After generating the initial Perlin noise (and before mapping it to the height map), various mathematical transformations can be applied to achieve desired effects and create more intricate 3D features (504). These transformations may involve scaling the noise values to adjust feature size, shifting them to control positioning within the map, or even combining them with other Perlin noise functions for increased complexity. For instance, a sinusoidal transformation can be employed to introduce periodic variations, resulting in features that repeat with a specific frequency.

In some examples, thresholding is applied on the Perlin noise (506). This includes setting a threshold value, and modifying the noise map such that values above the threshold are set to one value (e.g., high), and values below the threshold are set to another value (e.g., low). This can be used to create distinct features like cliffs or plateaus.

Features (defects) can be added to the height map by the addition of N (where N≥1) blobs to the height map, each blob corresponding to a 3D defect (508). N represents the number of individual 3D defects which are added to the height map.

In some examples, a texture can be selected (e.g., randomly) from a database comprising various textures (e.g., texture bank) and blended with the Perlin noise (510). The blending of the smooth, natural variations of Perlin noise with the more detailed and complex patterns from the texture bank, allows for the creation of a more realistic and intricate 3D feature in the height map.

Finally, the N 3D defects are planted in the height map to create the modified (augmented) height map (514) which is shown in comparison to the original, defect free wafer (516).

Notably, in some examples the entire process of generating 3D defects can be completely automatic, where, as mentioned above, the relevant type of 3D defects and their corresponding parameters are either predefined or selected in real-time (e.g., randomly or according to some predefined logic). In other examples, some human intervention may be required, e.g., for selecting the types of defects and/or their respective parameters. Optionally, in addition to 3D defects, 2D defects can also be added to the height map to enable the simulation of a mix of 3D and 2D defects in the final synthetic fault images.

Reverting to FIG. 4b, once the synthetic fault height maps have been generated, they are used for generating corresponding synthetic fault images (408). According to some examples, generation of the synthetic fault images is performed using a dedicated ML model (HM-2-IMAGE conversion ML model 115). This model is trained to receive height maps (e.g., synthetic fault height maps) as input, and generate corresponding examination output images (e.g., SEM output images). The resulting output of the ML model is a collection of synthetic fault images, that simulate examination output images of a semiconductor specimen with 3D (and possibly 2D) defects, as would have been generated by an examination tool. According to one example, when the examination output images initially received from the examination tool are SEM images, HM-2-IMAGE conversion ML model 115 is configured to generate synthetic fault SEM images.

As mentioned above, in a similar way, the system can also generate synthetic NVDs (synthetic fault-free images). These artificially generated NVDs are different from NVDs generated by the examination tool (“real-NVDs”) when scanning a defect-free specimen. Synthetic NVDs are generated by applying a similar operation flow to the one described above with reference to block 304, albeit without incorporating defects. This process includes transforming real NVDs into respective height maps, and then transforming the height maps into synthetic NVDs by applying the NVD height maps to the HM-2-IMAGE conversion ML model 115.

HM-2-IMAGE ML training module 119 is configured to train the HM-2-IMAGE conversion ML model 115. In some non-limiting examples, the HM-2-IMAGE conversion ML model is trained as a Pix2Pix model, which is a type of Generative Adversarial Network (GAN) specifically designed for image-to-image translation tasks, where the goal is to transform an input image into one or more corresponding output images. By way of example, the HM-2-IMAGE conversion ML model 115 can be pre-trained using a set of training samples, each comprising a height map and corresponding actual examination output images (e.g., SEM), each from a different perspective. The model can be trained to learn to map between the two image representations, a height map and the corresponding examination output images. Upon being trained, given the input of the height maps with implanted defects, the model can output synthetic fault images corresponding thereto. According to one non-limiting example, the height map can be represented as a grid, where each point is assigned a value between 0 and 1, with this normalized value indicating the relative height at that specific location. During machine learning training, this normalized format allows the model to consistently interpret the height information across the entire input, enabling it to learn how variations in these values correspond to features in the generated images.

FIG. 6a shows an example of transformation of height map H, comprising a blob, to respective synthetic fault SEM images showing the blob. As demonstrated in FIGS. 6a and 6b, for each height map more than one respective SEM image can be generated, each for a certain perspective, including top view and different side views. FIG. 6a shows, at the top, the synthetic fault height map and two perspectives of the corresponding synthetic fault SEM image where the topographic defect can be seen. Each of the two images, a and b, simulates the electron reflections received by a specific detector when scanning the specimen. As these detectors are positioned at different corners, each detector captures reflections from a unique angle. The images illustrate how the electron reflections vary based on the detector's position and orientation, providing a comprehensive view of the specimen's surface topography and particularly the blob. FIG. 6b shows another example featuring 3D defects created using Perlin noise, specifically demonstrating the appearance of Perlin scratches.

In some examples, such as when used for the purpose of training a ML learning model, once the synthetic fault images have been generated, they are mixed with fault-free images to create an updated training set for the defect detection ML model (410; e.g., by training set generator 117). The updated training set can be stored, for example, in storage unit 122, and made available to training module 106, which uses the training set for generating an augmented defect detection model 104. Notably, the training set can also include samples of other examination output images that include other types of defects. For example, training can also include real fault images with real defects (e.g., real fault images used to train previous models). This approach enables to obtain a comprehensive model capable of detecting various types of defects in one step.

In some examples, the augmented defect detection model 104 can be an updated (retrained) version of the previous defect detection ML model, where new defects are introduced to expand the defect detection ability of the existing model, while in other examples the augmented defect detection model 104 is a new ML model that replaces a previous defect detection model.

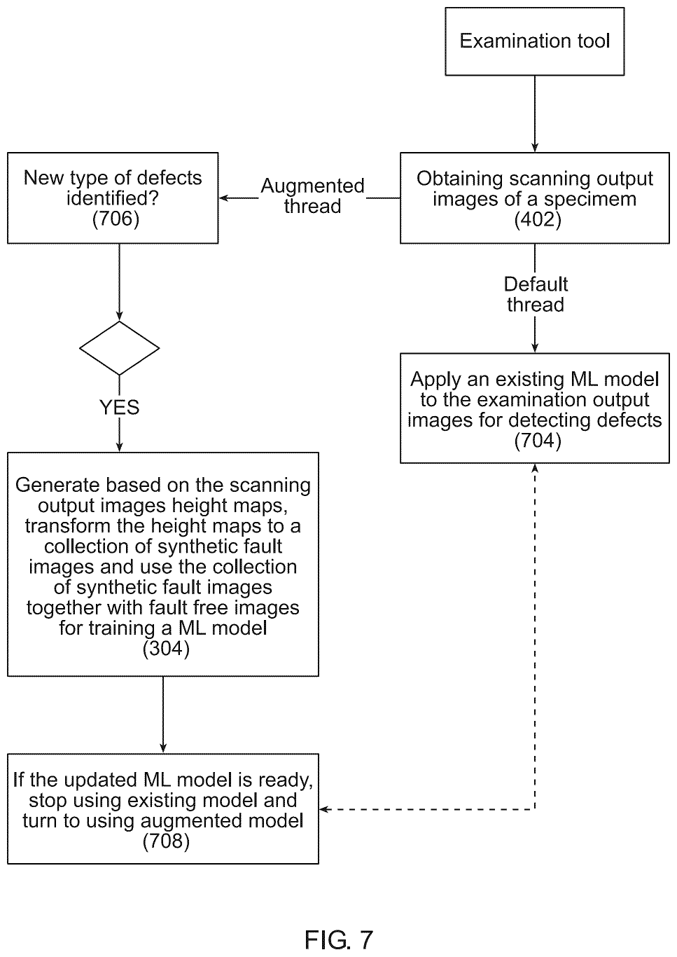

FIG. 7 is a flowchart showing an example of a defect detection process that includes dynamic update of the defect detection ML model. According to this approach examination output images are initially processed using an existing (or default) defect detection ML model (default thread 704). At the same time examination output images are being examined, and if the examination output data reveals a new type of defect that was not included in the training set, and thus the existing model was not trained to detect these defects (706), a dynamic model augmenting procedure is initiated. This procedure is dedicated for training an augmented ML model capable of detecting the new type of defect, as described above with reference to FIG. 4b (304). Once the augmented model is ready, it replaces the default ML model, and used in its stead for defect detection (708).

The synthetic defects that are added to the height maps to create the fault height maps as disclosed above represent the new type of defects found in the examination output images. A new type of 3D defect can be detected automatically or by a human reviewer. System 101 can respond to such a notification of a new defect type by initiating a process of generating an augmented defect detection ML model that is trained to identify the new type of defect. For example, system 101 can comprise a defect monitor 108 configured to identify new types of defects in examination output images or receive user input from a user indicating that a new type of defect has been identified, characterizing the defect to enable implanting of a respective 3D in the height map to ultimately update the defect detection ML model to identify this new type of defect, as explained above.

The synthetic fault images generated as described above effectively augment the training set used for training the defect detection model 104 with new examples of 3D defects and addresses the issues of lack of defective images needed for training the model, as well as the need to reduce the annotation efforts. By applying this process in real-time as part of the semiconductor examination process, possibly as part of the semiconductor fabrication flow, the system can automatically adapt on-the-fly for detecting new types of defects previously not disclosed in the training set, and thus improve its detection efficiency and accuracy.

In addition to dynamic updating of existing machine learning models, synthetic fault images can also be used for creating a training set of a machine learning model based on one or more predefined defects of interest, provided, for example, before the examination process. For a given semiconductor design, if it is desired to examine a particular type of 3D defect in the fabricated specimens, information on this defect can be provided to system 103. Based on this information, generation of the relevant synthetic fault images that exhibit these defects can be initiated. These images are subsequently used to train a defect detection ML model capable of detecting these defects. These defects are integrated in a height map to create respective synthetic fault images that comprise these defects to ensure the existence of a comprehensive variety of defects and use the defects in training a respective defect detection ML model.

As explained above, a height map generation algorithm that transforms examination output images (e.g., SEM images) to respective height maps is often used during the fabrication and examination of semiconductors. These height maps play an important role in quality control, process optimization, and defect analysis throughout various stages of semiconductor manufacturing. One example of the use of a height map generation algorithm is described above, where height maps are used in the generation of synthetic fault images. Other examples include using height maps to analyze surface topography for identifying potential defects, optimizing etching processes by providing detailed depth measurements, and enhancing the accuracy of lithography by ensuring precise layer thickness.

The presently disclosed subject matter introduces a new machine learning model dedicated for transforming examination output images to respective height maps. Additionally, it encompasses a computer-implemented method and a computer system configured to train and/or utilize this machine learning model.

Employing a machine learning model, instead of the height map generation algorithm, offers several technological advantages:

Reduced processing time: Simulating a height map with a height map generation algorithm is considerably more time-consuming than using a machine learning model. According to some examples, the former might take half a second to one second, whereas the latter can perform the same task in mere tens of milliseconds.

Enhanced output quality: The height map generation algorithm can introduce artifacts during the conversion of an examination output image such as an SEM image to a height map, leading to inaccuracies. As a result, height maps generated by this algorithm for specific images may contain various artifacts that degrade the overall quality. In contrast, a machine learning model can produce more accurate and artifact-free height maps.

As explained in more detail below, the machine learning model disclosed herein is specifically trained to remove artifacts introduced by the height map generation algorithm during the generation of height maps. Therefore, the output of the ML model, in addition to being generated faster than by the height map generation algorithm, is also more accurate, essentially improving the output of the height map generation algorithm.

In some examples a cyclic machine learning model that is trained to transform examination output images to height maps, and height maps to examination output images, can be concurrently generated. This saves time during training and helps to enhance the learning process and the accuracy of both models.

FIG. 1c illustrates another example of a block diagram of an examination system 100. FIG. 1c is a modified version of the examination system described above with reference to FIG. 1a, which further includes IMAGE-2-HM conversion model 114 (also referred to as “algorithm emulator ML model”) and IMAGE-2-HM ML training module 116. IMAGE-2-HM conversion model 114 is configured to emulate the height map generation algorithm by receiving an examination output image (e.g., SEM image) as input, and providing, as output, a respective height map. IMAGE-2-HM training module 116 is configured to execute the training of this model.

Similar to the synthetic image generator 110, in various examples either one or both of the IMAGE-2-HM conversion model 114 and the IMAGE-2-HM training module 116 can be implemented in different configurations. These configurations include, for example, being implemented as dedicated processing circuitry within a separate computer system/device (either part of or separate from synthetic image generator 110), being implemented as part of processing circuitry 102 in system 101, or being otherwise implemented within system 101, or within some other remote connected computer system.

Once the IMAGE-2-HM conversion model 114 has been trained, it can be used for generating height maps from examination output images. As mentioned above, one non-limiting example of the usage of IMAGE-2-HM conversion model 114, is during semiconductor examination, executed, for example, as part of semiconductor fabrication, where the ML model is used for generating height maps from scanning output images instead of the height map generation algorithm.

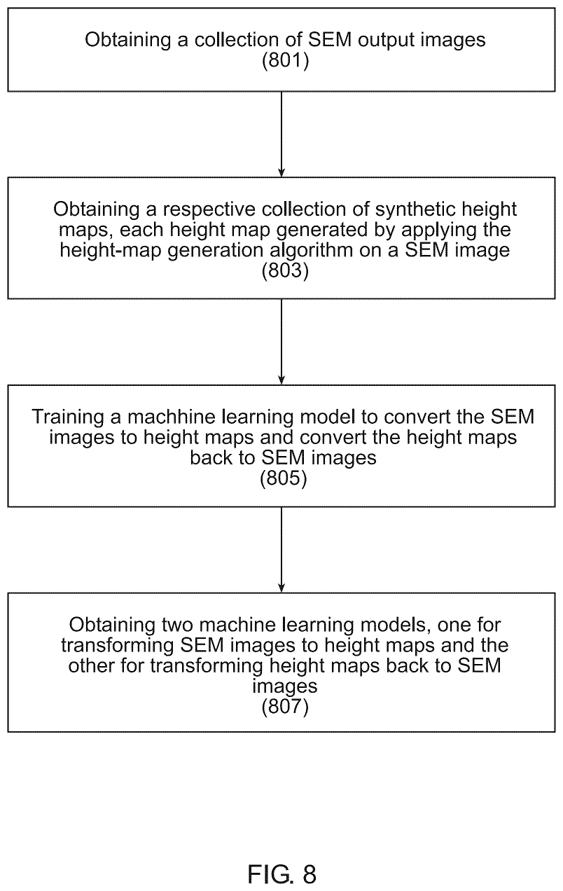

FIG. 8 is a flowchart of operations carried out as part of the training of IMAGE-2-HM conversion model 114, according to some examples of the presently disclosed subject matter (e.g., by IMAGE-2-HM training module 116).

Initially a collection of examination output images (e.g., SEM output images) is obtained, including different images generated by the scanning of different semiconductor specimens (801). The height map generation algorithm is applied on the examination output images to obtain respective height maps (803), thus obtaining a respective collection of height maps. As mentioned above, examination tools, such as a SEM, generate multiple images from different perspectives, each of which contributes to the generation of a single height map.

The collection of SEM output images and the respective collection of height maps are used as a training set for training a machine learning model dedicated for transforming SEM images to corresponding height maps (805).

In some examples, IMAGE-2-HM conversion model 114 is implemented as a deep neural network (DNN). DNN can refer to a supervised or unsupervised DNN model which includes layers organized in accordance with respective DNN architecture. By way of non-limiting example, the layers of DNN can be organized in accordance with Convolutional Neural Network (CNN) architecture, Recurrent Neural Network architecture, Recursive Neural Networks architecture, Generative Adversarial Network (GAN) architecture, or otherwise. Each layer of DNN can include multiple basic computational elements (CE), typically referred to in the art as dimensions, neurons, or nodes.

As mentioned above, the ML model can be implemented as a cyclic model which concurrently trains the conversion of SEM output images to height maps, and the conversion of height maps back to SEM images, essentially generating two models. In a specific example, a Cycle-Consistent Generative Adversarial Network (or CycleGAN) model can be used for this purpose. Cycle consistency refers to the principle that if an input is transformed from one domain to another, and then back to the original domain, the result should closely resemble the initial input. For example, in image-to-map and map-to-image translation, if a model converts a SEM image into a 3D map, and then translates that 3D map back into an image, the resulting image should be nearly identical to the original SEM image. A CycleGAN model is designed for learning to translate between two domains, without needing paired examples. It achieves this through a cyclic consistency loss that ensures the output can be transformed back to the input, making them ideal for tasks requiring cyclic transformations. They are effective for image-to-image translation tasks, where it is desired to transform an image from one domain to another, and then back again. The cyclic consistency ensures that the translated SEM can be converted back to the original SEM, maintaining its structure and details. Other examples include LSTM, GRU Networks, and Autoencoders.

As further mentioned above, the machine learning model disclosed herein is designed to reduce or eliminate artifacts that are commonly exhibited in height maps generated based on examination output images, such as those generated by non-ML height map generation algorithm, thereby enhancing the quality of the output produced by the machine learning model compared to the original height map generation algorithm.

Non-limiting examples of such artifacts include:

### Material Contrast Misinterpretation:

Scanning Electron Microscope (SEM) images often display variations in brightness due to differences in material composition, such as varying atomic numbers or elemental makeup, rather than just surface topography. When algorithms convert these SEM images into height maps, they may misinterpret the brightness variations caused by material contrast as changes in physical height. This misinterpretation leads to inaccurate height maps where areas composed of different materials incorrectly appear elevated or depressed, even though they share the same actual height.

### Shadowing Effects

During SEM imaging, the angle of electron detection and the sample's topography can create shadows and highlights in the image. Algorithms processing these images might incorrectly interpret these shadows and highlights as variations in surface height. As a result, the height map generated may contain false elevations or depressions corresponding to the shadowed or overly bright regions in the SEM image, which do not represent true topographical features.

### Charging Artifacts

Non-conductive or poorly conductive samples can accumulate electrical charge when exposed to the electron beam in SEM imaging. This accumulation leads to brightness anomalies in the SEM image, such as bright spots, streaks, or areas with altered contrast. When converting the SEM image to a height map, these brightness anomalies are misread as topographical features. Consequently, the height map includes spurious peaks or valleys that do not exist on the actual sample surface, leading to erroneous interpretations of the sample's topography.

To this end, a special loss function is designed to enhance smoothness of the height maps generated by the height map generation algorithm, by maintaining consistency between gradients in the SEM image and gradients in the respective height maps.

In some examples, the loss function includes at least some of the following components:

Reconstruction Component: This part is composed of two loss terms. The first one ensures that the machine learning model can replicate the function of the height map generation algorithm of transforming a SEM image into a corresponding height map. The second loss term ensures that the machine learning model can transform a height map image into a corresponding SEM image. For example, mean squared error, or mean absolute error can be used for each of these loss terms.

Adversarial Component: In case a generative adversarial model is employed, the adversarial component comprises two loss terms: one adversarial loss term associated with the generator and discriminator for converting height maps to SEM images, and another adversarial loss term associated with the generator and discriminator for converting SEM images to height maps. These loss terms function to optimize the respective generators by encouraging them to produce outputs that are indistinguishable from real data in the target domain. The benefit of incorporating these loss terms is that they enhance the realism and accuracy of the generated images, improving the model's ability to effectively translate between height maps and SEM images. This dual adversarial training approach ensures consistency in both directions of conversion, reducing artifacts and resulting in more reliable and high-quality outputs suitable for practical applications.

Cycle-Consistency Component: This component ensures that the model retains its cycle-consistency capability to enhance the SEM image to height map, and height map to SEM image generation models. It is composed of two loss terms. The first term ensures that the conversion from height map to SEM image is cycle consistent, and the second one ensures SEM image to height map is cycle consistent.

Smoothing Component: This component ensures gradient consistency between the outputs, comprising two loss terms. A first loss term ensures that the gradients of height maps generated by the ML model are consistent with the gradients of the generated SEM images. A second loss term ensures that the gradients of the generated SEM images generated by the ML model are consistent with the gradients of the generated height maps.

This collection of attributes provides a ML model that significantly improves the output originally provided by the height map generation algorithm which it emulates.

This training process ultimately provides two machine learning models, a first ML model (IMAGE-2-HM conversion model 114) for transforming SEM images to corresponding height maps, and a second ML model (HM-2-IMAGE conversion model 115) for transforming the height maps back to corresponding SEM images.

Following training, during inference, the first model can be applied on SEM images to convert them to height maps, and the second model can be applied on height maps to convert them to SEM images.

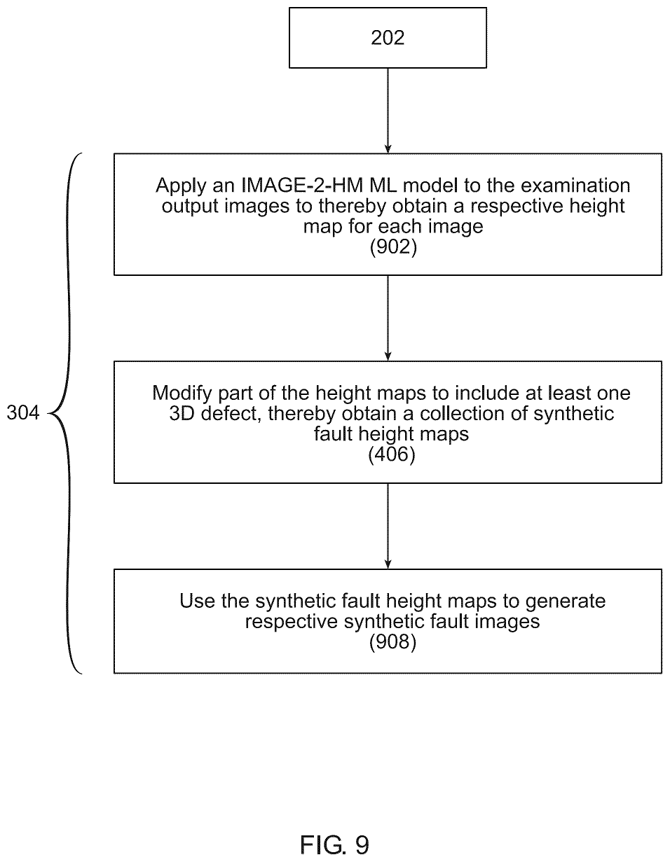

FIG. 9 is a flowchart showing an alternative approach for the generation of synthetic fault images described above with reference to FIG. 4a. According to some examples, following training, IMAGE-2-HM conversion model 114 and HM-2-IMAGE conversion model 115 are made available to synthetic image generator 110 to be used during the generation of synthetic images.

At block 902, which replaced block 402 in FIG. 4a, instead of using a height map generation algorithm, height maps are generated by applying the IMAGE-2-HM conversion model 114 on SEM output images. As explained above, IMAGE-2-HM conversion model 114 assists in removing artifacts that are often seen in height maps generated by a height map generation algorithm.

As explained above, various processing techniques, including those based on procedural generation, can be used for implanting defects in the height maps, and thus obtaining synthetic fault height maps (406; e.g., by defect implanting module 113).

Following synthetic defects implanting, HM-2-IMAGE conversion model 115 is applied on the synthetic fault height maps to obtain synthetic fault SEM images that exhibit the 3D defects implanted in the height maps (908). As explained above, the IMAGE-2-HM and HM-2-IMAGE models can be implemented as a cyclic model (e.g., CyclicGAN), where both models are generated together in one process.

The above process can be used for generating synthetic fault SEM images that can be used for various purposes. As exemplified above with respect to FIG. 4b, generation of the synthetic fault images can be used in the training of an augmented machine learning model dedicated for detecting defects in SEM images, as well as for various other purposes.

The disclosed subject matter further includes a machine learning model dedicated for transforming a material map into a corresponding synthetic examination output image, including both synthetic fault images and synthetic fault-free images. Additionally, a computer-implemented method and a computer system are disclosed, configured for training and/or utilizing this machine learning model.

A material map of a semiconductor specimen is a detailed spatial representation that characterizes the distribution and composition of different materials across the surface and subsurface of the specimen. This map typically distinguishes regions composed of various semiconductor materials (such as silicon, germanium, gallium arsenide, or indium phosphide) and may also identify the presence of dopants, oxides, and other compounds. The material map provides a visual or numerical depiction of material heterogeneity, which is crucial for understanding material properties, identifying defects, and optimizing semiconductor device performance.

By incorporating material maps into the training process, the machine learning model can more accurately simulate synthetic examination output images. This integration allows the model to account for variations in material composition, leading to more realistic and effective outputs. It also enables the creation of synthetic fault images that include specific material defects (e.g., simulating images where incorrect materials were used during fabrication), as well as images that combine both 3D and material defects.

In some examples, the HM-2-IMAGE conversion ML model (115) is adapted to incorporate both height maps and material maps into its training process, utilizing at least two input channels. The first input channel processes height maps, while the second processes material maps. Each channel is trained with its respective training set, one being trained to convert height maps to examination output images, and the other to convert material maps to examination output images. When combined, these inputs are used by the model in runtime to create a comprehensive representation of the semiconductor specimen, capturing the intricate details of both its topography and material composition.

The model can be enhanced by integrating material defects in the input of the second channel alongside structural defects in the input of the first channel, allowing it to learn how both types of defects-3D structural and material-based-affect the examination output images. By training on this combined input, the model becomes capable of generating examination output images, such as SEM images, that accurately simulate the appearance of these defects, reflecting both the structural and material properties of the specimen.

The model can also be used to focus specifically on material defects, allowing it to simulate how variations in material composition impact the examination output images independently of structural defects. This enables the generation of synthetic fault images that accurately reflect material-specific issues within the semiconductor specimen.

As a result, the synthetic fault images produced by the model offer a highly realistic simulation of what would be observed by an examination tool, providing a comprehensive understanding of how both topographical and material inconsistencies impact the integrity of the semiconductor specimen.

In some examples, a cyclic machine learning model, as explained above with respect to FIG. 8, that is trained to transform examination output images (e.g., SEM images) to height maps and material maps, and height maps and material maps to examination output images, can be used.

Those versed in the art will readily appreciate that the teachings of the presently disclosed subject matter are not bound by the system illustrated in FIGS. 1a, 1b, and 1c. Each system component and module in FIGS. 1a, 1b, and 1c can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified, and/or different components, modules, and functions than those shown in FIGS. 1a, 1b, and 1c.

Each component in FIGS. 1a, 1b, and 1c may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

While certain examples of the present disclosure refer to a processing circuitry being configured to perform the above recited operations, the functionalities/operations of the aforementioned functional modules can be performed by the one or more processors in the processing circuitry in various ways. By way of example, the operations of each module can be performed by a specific processor, or by a combination of processors. The operations of the various functional modules, such as processing the examination/inspection image, and performing defect examination, etc., can thus be performed by respective processors (or processor combinations), while, optionally, these operations may be performed by the same processor. The present disclosure should not be limited to being construed as one single processor always performing all the operations. Furthermore, any reference made in the specification and claims to a single processing circuitry should be interpreted to optionally include multiple processing circuitries.

The systems illustrated in FIGS. 1a, 1b, and 1c can be implemented in a distributed computing environment, in which one or more of the aforementioned components and functional modules shown in FIGS. 1a, 1b, and 1c can be distributed over several local and/or remote devices. By way of example, the examination tool 120 and systems 101 and/or 103 can be located at the same entity (in some cases hosted by the same device) or distributed over different entities, each located at a different location.

In some examples, certain components utilize a cloud implementation, e.g., implemented in a private or public cloud. Communication between the various components of the examination system, in cases where they are not located entirely in one location or in one physical entity, can be realized by any signaling system or communication components, modules, protocols, software languages and drive signals, and can be wired and/or wireless, as appropriate.

Unless specifically stated otherwise, as apparent from the above discussions, it is appreciated that, throughout the specification, discussions utilizing terms such as “obtaining”, “generating”, “applying”, “executing”, “utilizing”, “modifying” or the like, include an action and/or processes of a computer that manipulate and/or transform data into other data, said data represented as physical quantities, e.g. such as electronic quantities, and/or said data representing the physical objects.

The terms “computer”, “computer system”, “computer device”, “computerized device”, “computerized system” or the like used herein, should be expansively construed to include any kind of hardware-based electronic device with one or more data processing circuitries. Each processing circuitry can comprise, for example, one or more processors operatively connected to computer memory, capable of executing stored instructions to perform the operations described herein. Any reference made in the description or claims to a processing circuitry should be construed to include also multiple processing circuitries.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a graphics processing unit (GPU), a network processor, or the like.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately, or in any suitable sub-combination.

In various examples of the presently disclosed subject matter, fewer, more and/or different stages than those shown in FIGS. 2, 3, 4a, 4b, 7, 8, and 9, may be executed. In some examples one or more stages illustrated in the figures may be executed in a different order, and/or one or more groups of stages may be executed simultaneously.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable (e.g., non-transitory) memory tangibly embodying a program of instructions executable by the machine for executing the method of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A computer system configured to generate height maps of a semiconductor specimen, the computer system comprising at least one processing circuitry configured to:
obtain one or more examination output images generated by a semiconductor examination tool;
apply a first machine learning (ML) model on the one or more examination output images to generate one or more respective height maps; wherein the first machine learning model is a model trained with a training dataset that includes examination output images of a semiconductor specimen and respective height maps, and is dedicated to converting examination output images to height maps while avoiding artifacts commonly found in height maps generated based on examination output images, by utilizing a loss function dedicated to maintaining consistency between the examination output images and the respective height maps.

2. The computer system of claim 1, wherein the at least one processing circuitry is configured to:
modify the one or more respective height maps by adding at least one topographic feature, thereby generating one or more modified height maps; and
apply a second machine learning (ML) model to the one or more modified height maps to convert the one or more modified height maps to one or more respective modified synthetic examination output images of the semiconductor specimen.

3. The computer system of claim 2, wherein the first ML model and the second ML model are trained concurrently in a cyclic training process.

4. The computer system of claim 2, wherein the first machine learning model and the second machine learning model each apply a loss function dedicated to maintaining consistency between the examination output images and the respective height maps; wherein the loss function includes at least a loss component configured to maintain correlation between gradients in the one or more examination output images and the respective one or more height maps to thereby avoid the insertion of artifacts.

5. The computer system of claim 2, wherein a new topographic feature is an artificially generated 3D defect, wherein the one or more modified height maps include at least one fault height map that includes at least one artificially generated 3D defect, and wherein the one or more modified examination output images include one or more synthetic fault images, exhibiting at least one artificially generated 3D defect.

6. The computer system of claim 5, wherein the at least one processing circuitry is configured to generate the one or more synthetic fault images as part of execution of a defect detection process, dedicated for detecting 3D defects in examination output images of a semiconductor; wherein the at least one processing circuitry is further configured to execute as part of the defect detection process:
generate a training dataset comprising a collection of examination output images including the one or more synthetic fault images and a plurality of fault-free images;
utilize the training dataset for training a third machine learning model dedicated for receiving examination output images of a semiconductor specimen and detecting defects therein; and
apply the third machine learning model to examination output images of the semiconductor specimen acquired by the examination tool, to thereby detect defects in the semiconductor specimens.

7. The computer system of claim 6, wherein the defect detection process is executed as part of a semiconductor examination process for detecting defects in real-time during examination.

8. The computer system of claim 2, wherein the at least one processing circuitry is configured to:
obtain one or more material maps of the semiconductor specimen; wherein a material map represents the distribution and composition of different materials across the semiconductor specimen; the one or more material maps are modified material maps that each include at least one artificially generated material defect;
apply the second machine learning (ML) model to the one or more material maps in addition to the modified height maps, to convert the one or more modified height maps and material maps to one or more respective modified synthetic examination output images that include at least one 3-dimensional defect and at least one material defect.

9. The computer system of claim 1, wherein the examination tool is a Scanning Electron Microscope (SEM) and the examination output images are SEM output images.

10. The computer system of claim 1, wherein the one or more examination output images include one or more fault-free images; wherein the processing circuitry is further configured to:
apply the first ML model on the one or more fault-free images, thereby obtaining one or more respective height maps;
apply a second machine learning (ML) model to the one or more respective height maps to convert the one or more height maps to one or more respective synthetic fault-free images of the semiconductor specimen.

11. A computer-implemented method of generating height maps of a semiconductor specimen, the method comprising:
obtaining one or more examination output images generated by a semiconductor examination tool;
applying a first machine learning (ML) model on the one or more examination output images to generate one or more respective height maps; wherein the first machine learning model is a model trained with a training dataset that includes examination output images of a semiconductor specimen and respective height maps, and is dedicated to converting examination output images to height maps while utilizing a loss function dedicated to maintaining consistency between the examination output images and the respective height maps to thereby reduce artifacts commonly found in height maps generated based on examination output images.

12. The computer-implemented method of claim 11 comprising:
modifying the one or more respective height maps by adding at least one topographic feature, thereby generating one or more modified height maps; and
applying a second machine learning (ML) model to the one or more modified height maps to convert the one or more modified height maps to one or more respective modified synthetic examination output images of the semiconductor specimen.

13. The computer-implemented method of claim 12, wherein the first ML model and the second ML model are trained concurrently in a cyclic training process.

14. The computer-implemented method of claim 13, wherein the first machine learning model and the second machine learning model each apply a loss function dedicated to maintaining consistency between the examination output images and the respective height maps; wherein the loss function includes at least a loss component configured to maintain correlation between gradients in the one or more examination output images and the respective one or more height maps to thereby avoid the insertion of artifacts.

15. The computer-implemented method of claim 12, wherein a new topographic feature is an artificially generated 3D defect, wherein the one or more modified height maps include at least one fault height map that includes at least one artificially generated 3D defect, and wherein the one or more modified examination output images include one or more synthetic fault images, exhibiting data indicative of the at least one artificially generated 3D defect.

16. The computer-implemented method of claim 15, wherein the one or more synthetic fault images are generated as part of execution of a defect detection process, dedicated for detecting 3D defects in examination output images of a semiconductor; the method further comprises, as part of the defect detection process:
generating a training dataset comprising a collection of examination output images including the one or more synthetic fault images and a plurality of fault-free images;
utilizing the training dataset for training a third machine learning model dedicated for receiving examination output images of a semiconductor specimen and detecting defects therein; and
applying the third machine learning model to examination output images of the semiconductor specimen acquired by the examination tool, to thereby detect defects in the semiconductor specimens.

17. The computer-implemented method of claim 16, wherein the defect detection process is executed as part of a semiconductor examination process for detecting defects in real-time during examination.

18. The computer-implemented method of claim 13, comprising:
obtaining one or more material maps of the semiconductor specimen; wherein a material map represents the distribution and composition of different materials across the semiconductor specimen; the one or more material maps are modified material maps that each include at least one artificially generated material defect;
applying the second machine learning (ML) model to the one or more material maps in addition to the modified height maps to convert the one or more modified height maps and material maps to one or more respective modified synthetic examination output images that include at least one 3-dimensional defect and at least one material defect.

19. The computer-implemented method of claim 11, wherein the one or more examination output images include one or more fault-free images; the method comprising:
applying the first ML model on the one or more fault-free images, thereby obtaining one or more respective height maps;
applying a second machine learning (ML) model to the one or more respective height maps to convert the one or more height maps to one or more respective synthetic fault-free images of the semiconductor specimen.

20. A computer program product comprising a non-transitory computer-readable medium having computer-executable instructions stored thereon, which, when executed by a processor, cause the processor to execute a method of generating height maps of a semiconductor specimen, the method comprising:
obtaining one or more examination output images generated by a semiconductor examination tool;
applying a first machine learning (ML) model on the one or more examination output images to generate one or more respective height maps; wherein the first machine learning model is a model trained with a training dataset that includes examination output images of a semiconductor specimen and respective height maps, and is dedicated to converting examination output images to height maps while utilizing a loss function dedicated to maintaining consistency between the examination output images and the respective height maps to thereby reduce artifacts commonly found in height maps generated based on examination output images.
